(19) United States
(12) Patent Application Publication
(10) Pub. No.: US 2025/0284571 A1
(43) Pub. Date: Sep. 11, 2025

(54) NETWORK INTERFACE DEVICE CAPABLE OF SUPPORTING HIGH PERFORMANCE AND HIGH SCALABILITY AND SYSTEM INCLUDING THE SAME

(71) Applicant: MANGOBOOST, INC., Bellevue, WA (US)

(72) Inventor: Kanghyun CHOI, Seoul (KR)

(21) Appl. No.: 19/070,568

(22) Filed: Mar. 5, 2025

(30) Foreign Application Priority Data
Mar. 5, 2024 (KR) 10-2024-0031578
Feb. 25, 2025 (KR) 10-2025-0024449

(51) Int. Cl. G06F 9/54; H04L 67/61

(52) U.S. Cl. CPC G06F 9/544; H04L 67/61

(57) ABSTRACT

A network interface device is configured for simultaneously processing Y (where Y is a positive integer of 2 or more) queue pair (QP) connections for X (where X is a positive integer) send work queue elements (WQEs) or receive WQEs. The network interface device includes: a shared WQE memory having a size corresponding to N (a positive integer less than or equal to 1/n of X*Y, where n is a positive integer of 2 or more) send WQEs; and a first doorbell controller configured to count free regions in the shared WQE memory and control processing of a first doorbell received from an external source.

### CROSS-REFERENCE TO RELATED APPLICATION(S)

This application claims benefit of priority to Korean Patent Application Nos. 10-2024-0031578, filed on Mar. 5, 2024, and 10-2025-0024449, filed on Feb. 25, 2025, in the Korean Intellectual Property Office, the disclosures of which are incorporated herein by reference in their entirety.

### BACKGROUND

The present disclosure relates to a network interface device and a system including the same, and more particularly, to a network interface device capable of supporting high performance and high scalability, and a system including the same.

There is an ever-increasing demand for improvements in data processing capacity and data processing speed. In order to meet these demands, research and development are being conducted on network interface devices that can increase the number of supported network connections while maintaining high bandwidth and low latency.

However, since the number of network connections and bandwidth have a trade-off relationship, if a network interface device processes more than a certain number of network connections simultaneously, the bandwidth may drop sharply, causing scalability problems. In the case of commercial network interface devices such as Nvidia ConnectX-6, if the number of queue pair (QP) connections exceeds 256, the bandwidth drops sharply, resulting in performance degradation to around 70 Gbps at 512 connections and 60 Gbps at 2,048 connections.

### SUMMARY

The present disclosure provides a network interface device capable of supporting the maximum number of network connections, such as QP connections, while maintaining high bandwidth and low latency, and a system including the same.

A network interface device according to an embodiment of the present disclosure is a network interface device for simultaneously processing Y (where Y is a positive integer of 2 or more) queue pair (QP) connections for X (where X is a positive integer) send work queue elements (WQEs) or receive WQEs, the network interface device includes: a shared WQE memory having a size corresponding to N (where N is a positive integer less than or equal to 1/n of X*Y, n is a positive integer of 2 or more) send WQEs; and a first doorbell controller configured to count free regions of the shared WQE memory and control processing of a first doorbell received from an external source.

A network interface device according to an embodiment of the present disclosure is a network interface device for simultaneously processing Y (where Y is a positive integer of 2 or more) queue pair (QP) connections for X (where X is a positive integer) send work queue elements (WQEs) or receive WQEs, the network interface device includes: a WQE prefetcher configured to prefetch M (where M is a positive integer less than or equal to 1/m of X*Y, m is a positive integer of 2 or more) receive WQEs; and a response pipeline configured to output an error response when a null WQE is received via the WQE prefetcher.

A system according to an embodiment of the present disclosure includes a network interface device for simultaneously processing Y (where Y is a positive integer of 2 or more) queue pair (QP) connections for X (where X is a positive integer) send work queue elements (WQEs) or receive WQEs, wherein the network interface device includes: a request processing module configured to process remote direct memory access (RDMA) requests, including a shared WQE memory having a size corresponding to N (where N is a positive integer less than or equal to 1/n of X*Y, n is a positive integer of 2 or more) send WQEs; and a response processing module configured to process RDMA responses corresponding to the RDMA requests, including a WQE prefetcher configured to prefetch M (where M is a positive integer less than or equal to 1/m of X*Y, m is a positive integer of 2 or more) receive WQEs.

According to a network interface device and a system including the same of the present disclosure, it is possible to support a certain number of QP connections or more while maintaining high bandwidth and low latency by including a shared work queue element memory or a WQE prefetcher. According to an embodiment, when a remote direct memory access (RDMA) protocol is applied, the network interface device and the system including the same according to embodiments of the present disclosure can maintain a high bandwidth of 100 Gbps while simultaneously processing more than 10,000 QP connections.

According to a network interface device and a system including the same of the present disclosure, it is possible to provide connection scalability in a state compatible with commercial network interface devices.

According to a network interface device and a system including the same of the present disclosure, changes to the network protocol are unnecessary, so connection scalability can be provided in a state compatible with commercial network interface devices.

According to a network interface device and a system including the same of the present disclosure, high performance and high scalability can be supported by minimizing CPU intervention in request processing or response processing.

The effects that can be obtained from the exemplary embodiments of the present disclosure are not limited to the effects mentioned above, and other effects not mentioned can be clearly derived and understood by those skilled in the art to which the exemplary embodiments of the present disclosure belong from the following description. In other words, unintended effects resulting from implementing the exemplary embodiments of the present disclosure can also be derived by those skilled in the art from the exemplary embodiments of the present disclosure.

### BRIEF DESCRIPTION OF THE DRAWINGS

FIG. 1 is a view illustrating a system according to an embodiment of the present disclosure;

FIG. 2 is a view illustrating an operation of a system according to an embodiment of the present disclosure transmitting request packets and response packets through a network fabric;

FIG. 3 is a view illustrating an operation of processing a request packet in a network interface device according to an embodiment of the present disclosure.

FIG. 4 is a view illustrating an operation of a request pipeline according to an embodiment of the present disclosure.

FIG. 5 is a view illustrating an operation of a completion pipeline according to an embodiment of the present disclosure.

FIG. 6 is a view illustrating an operation of a WQE controller according to an embodiment of the present disclosure.

FIG. 7 is a view illustrating an operation of generating a response packet according to an embodiment of the present disclosure.

FIG. 8 is a view illustrating an operation of a response pipeline according to an embodiment of the present disclosure.

FIG. 9 is a flowchart illustrating a portion of the operation of a WQE prefetcher according to an embodiment of the present disclosure.

### DETAILED DESCRIPTION OF EXEMPLARY EMBODIMENTS

Hereinafter, embodiments of the present disclosure will be described in detail with reference to the drawings so that those skilled in the art to which the present disclosure pertains can easily implement them. However, the present disclosure can be implemented in various different forms and is not limited to the embodiments described herein. In the description of the drawings, the same or similar reference numerals may be used for the same or similar components. In addition, in the drawings and related descriptions, descriptions of well-known functions and configurations may be omitted for clarity and conciseness.

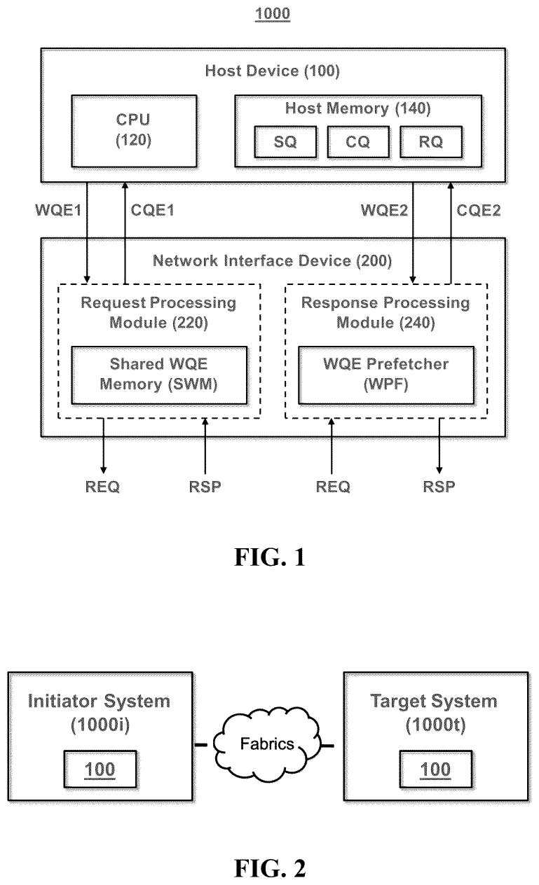

FIG. 1 is a view illustrating a system 1000 according to an embodiment of the present disclosure.

Referring to FIG. 1, the system 1000 according to an embodiment of the present disclosure includes a host device 100 and a network interface device 200. The system 1000 may be all or part of a data center server or a stand-alone server, a computer cluster, a cloud storage, a cloud data center, a high-performance computing system (HPC), a high-frequency trading system (HFT), or an automotive computing system that may send, receive, and process data, files, objects, and information.

The host device 100 may include a central processing unit (CPU) 120 and a host memory 140. The CPU 120 may be implemented as a single-core or multi-core processor for executing commands of the operating system or other applications of the host device 100. The host memory 140 may include dynamic random access memory (DRAM) or the like and store data required for the operation of the host device 100. The host memory 140 may include a send queue (SQ) storing a send work queue element (WQE) WQE1, a receive queue (RQ) storing a receive WQE WQE2, and a completion queue (CQ) storing a first completion queue element (CQE) CQE1 or a second CQE CQE2.

The network interface device 200 may directly process network packets with minimized CPU intervention by utilizing CPU offloading techniques such as kernel bypass or zero-copy. Therefore, the network interface device 200 and the system 1000 including the same according to an embodiment of the present disclosure may realize high-speed data transmission, low latency, and high network throughput. In one embodiment, the network interface device 200 may be a separate hardware device from the host device 100 and may be provided in the form of a card, a system-on-chip (SoC), or a neural processing unit (NPU), and may be implemented with a field programmable gate array (FPGA) and an application-specific integrated circuit (ASIC).

In one embodiment, the network interface device 200 may support the remote direct memory access (RDMA) protocol. However, the present disclosure is not limited thereto. The network interface device 200 according to an embodiment of the present disclosure may also support other communication protocols capable of CPU offloading, either alone or in combination with RDMA.

The network interface device 200 may include a request processing module 220 configured to process a request packet REQ. The request processing module 220 may output the request packet REQ in response to a request from the host device 100. Hereinafter, the request transmitted from the host device 100 to the network interface device 200 and the request packet REQ output by the network interface device 200 may be used separately as necessary. Alternatively, the request and the send WQE WQE1 may be used interchangeably as necessary.

The request processing module 220 may include a shared WQE memory SWM. The request processing module 220 may store the send WQE WQE1 fetched from the host memory 140 in the shared WQE memory SWM and generate it as a request packet REQ. In addition, the request processing module 220 may receive a response packet RSP corresponding to the request packet REQ and store the first CQE CQE1 indicating completion of the request or consumption of the send WQE WQE1 in the host memory 140.

The network interface device 200 may include a response processing module 240 configured to generate the response packet RSP. The response processing module 240 may include a WQE prefetcher WPF. The WQE prefetcher WPF may prefetch and store the receive WQE WQE2 from the host memory 140. The response processing module 240 may receive the request packet REQ and process the receive WQE WQE2 stored in the WQE prefetcher WPF. Through such an operation, the response processing module 240 may output the response packet RSP and store the second CQE CQE2 indicating that the receive WQE WQE2 has been consumed in the host memory 140.

The send WQE WQE1 and the receive WQE WQE2 may be generated including an “Opcode” field indicating an RDMA command to be executed, such as “SEND”, “WRITE”, or “READ”, a “work request identifier” (WR ID) field used to identify the corresponding operation in the CQ of the host memory 140 when processing the request packet REQ is completed, a pointer “Next WQE Ptr” field pointing to the next WQE, an “LKEY/RKEY” field which is a key value for memory access, a “Length” field indicating the data length to be transmitted, and a “QP Number” field indicating the QP number to which the corresponding WQE belongs.

The first CQE CQE1 and the second CQE CQE2 may also be implemented as a structure similar to the send WQE WQE1 and the receive WQE WQE2. The first CQE CQE1 and the second CQE CQE2 may additionally include a “Status” field indicating whether the request was successful or erroneous.

Although FIG. 1 shows the request processing module 220 and the response processing module 240 as separate modules, this is for convenience of illustration only, and some hardware configurations may be shared by the request processing module 220 and the response processing module 240.

FIG. 2 is a view illustrating an operation of the system 1000 according to an embodiment of the present disclosure, in which the system transmits a request packet REQ and a response packet RSP through a network fabric.

Referring to FIGS. 1 and 2, the system 1000 according to an embodiment of the present disclosure may be an initiator system 1000i. Alternatively, the system 1000 according to an embodiment of the present disclosure may be a target system 1000t.

The initiator system 1000i and the target system 1000t are each implemented and operated with the structure of the system 1000 of FIG. 1, and may transmit a request packet REQ and a response packet RSP through a network fabric. The initiator system 1000i may generate a request packet REQ and transmit it to the target system 1000t through the network fabric. The target system 1000t may generate a response packet RSP corresponding to the received request packet REQ and transmit it to the initiator system 1000i through the network fabric.

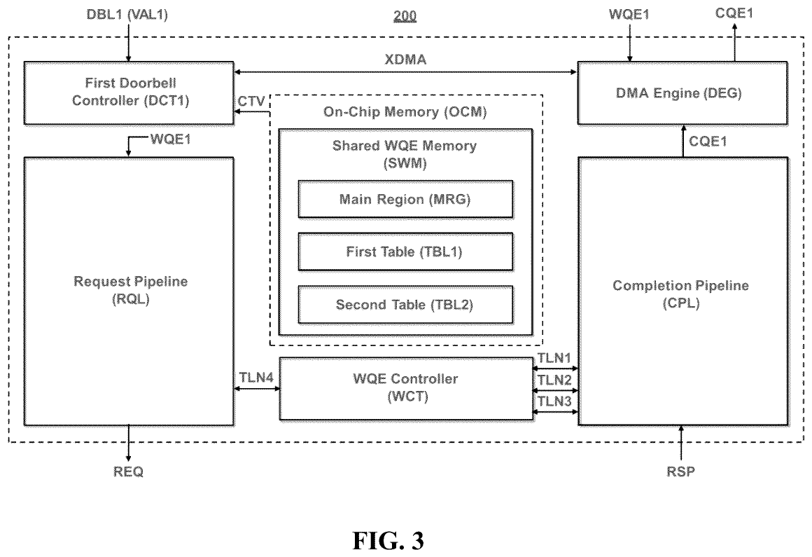

FIG. 3 is a view illustrating an operation of processing a request packet REQ in the network interface device 200 according to an embodiment of the present disclosure.

Referring to FIGS. 1 and 3, the network interface device 200 according to an embodiment of the present disclosure may include a shared WQE memory SWM and a first doorbell controller DCT1.

The shared WQE memory SWM may be shared by multiple QPs. In other words, each entry of the shared WQE memory SWM is not specified by a specific QP, but may be shared by different QPs. For example, a first entry of the shared WQE memory SWM may store a send WQE for a first QP at one point in time, and store a send WQE for a second QP at another point in time.

In one embodiment, the shared WQE memory SWM may be implemented as a partial region of an on-chip memory OCM of the network interface device 200. The on-chip memory OCM may be or include static random access memory (SRAM).

RDMA-based network interface devices, such as RDMA network interface cards (NICs), may encounter connection scalability problems due to the size limitation of the on-chip memory OCM. The size limitation of the on-chip memory OCM may result from cost or chip layout constraints. If metadata for each QP is stored in the on-chip memory OCM, the resources that may be allocated to individual QPs decrease as the total number of QP connections increases, resulting in performance degradation. Particularly, in large-scale data centers or cloud environments, it is often necessary to maintain thousands to millions or more of QP connections, so performance issues due to the on-chip memory OCM may arise for the number of QP connections required to be processed by individual network interface devices.

The network interface device 200 and the system 1000 including the same according to an embodiment of the present disclosure, connection scalability for QP connections may be guaranteed by including a shared WQE memory SWM that may be shared by a plurality of QPs and has a minimum size, and controlling the operation so as not to cause performance degradation due to the size of the shared WQE memory SWM.

In one embodiment, when the network interface device 200 may simultaneously process Y (Y is a positive integer of 2 or more) QP connections for X (X is a positive integer) send WQEs WQE1s or receive WQEs WQE2s, the shared WQE memory SWM may be provided with a size corresponding to N (where N is a positive integer less than or equal to 1/n of X*Y, n is a positive integer of 2 or more) send WQEs WQE1s.

The network interface device 200 must store the corresponding send WQE WQE1 internally until the processing of the send WQE WQE1 is completed, for example, until a response packet RSP is received and the first CQE CQE1 is generated. In one embodiment, the shared WQE memory SWM may be provided with a size corresponding to the maximum number of requests that the network interface device 200 may be in-flight at one point in time.

In one embodiment, N may be set corresponding to network bandwidth, the number of end-to-end switch hops, and switch processing latency. For example, in a 3-level clos network with 400 Gbps bandwidth, consisting of an ingress layer, an intermediate layer, and an egress layer and a switching latency of 1 μs, the number of in-flight requests may be calculated as approximately 150 based on 4 KB request according to the following equation.

Bandwidth*Number of End-to-End Switch Hops*Switching Latency/Request Size=400 Gbps*12*1 μs/4 KB≈150 Mathematical Equation

Note that the example of “12” as the number of switches traversed end-to-end may be an example of the number of switches traversed in the round-trip path where the request packet REQ is transmitted from the initiator system 1000i to the target system 1000t and the response returns to the initiator system 1000i.

In one embodiment, if the network interface device 200 may simultaneously support 10,000 QP connections with a QP depth of 1,024, the on-chip memory OCM usage of the send WQE WQE1 may be significantly reduced by storing only N number of send WQEs WQE1s in the shared WQE memory SWM instead of storing all 10,000*1,024 send WQEs WQE1s in the network interface device 200, while maintaining performance.

The shared WQE memory SWM may include a main region MRG, a first table TBL1, and a second table TBL2. The send WQE WQE1 may be stored in the main region MRG. The first table TBL1 may store an index for a region or an entry in the main region MRG where the send WQE WQE1 is stored, along with the QP identifier (a unique number). The second table TBL2 may store indices for regions or entries in the main region MRG where the send WQE WQE1 is not stored, i.e., free regions.

The first doorbell controller DCT1 may control processing of a first doorbell DBL1 received from the host device 100 by counting the free regions of the shared WQE memory SWM.

When a number of send WQEs WQE1s set to a first value VALI are stored in the SQ of the host memory 140 in response to a user's request, the host device 100 may transmit the first doorbell DBL1 to the network interface device 200 to notify this. For example, the first value VALI may be set to “8”, and the first doorbell DBL1 may be transmitted when 8 new send WQEs WQE1s are stored in the SQ.

In one embodiment, when the first doorbell DBL1 is received, the first doorbell controller DCT1 may update the write pointer value of the SQ stored in a register (not shown). In one embodiment, the first doorbell controller DCT1 may calculate a count value CTV for the free regions of the shared WQE memory SWM by referring to the second table TBL2.

In one embodiment, the first doorbell controller DCT1 may calculate the number of available entries included in the shared WQE memory SWM as the count value CTV. If the second table TBL2 of the shared WQE memory SWM indicates Index #1 to Index #4 as free regions, the first doorbell controller DCT1 may generate the count value CTV as “4”.

In one embodiment, if the first value VALI indicated by the first doorbell DBL1 is greater than the count CTV for the free regions of the shared WQE memory SWM, the first doorbell controller DCT1 may ignore the first doorbell DBL1. If the first doorbell DBL1 is received at a first time point, and the first value VALI is “8” and the count value CTV is “4” as in the example described above, the first doorbell controller DCT1 may not perform any processing on the first doorbell DBL1 received at the first time point. If the count value CTV is changed to “8” at a second time point, the first doorbell controller DCT1 may process the first doorbell DBL1 received at the first time point.

The network interface device 200 according to embodiments of the present disclosure may further include a DMA engine DEG. In one embodiment, the DMA engine DEG may fetch a number of send WQE WQE1 corresponding to the first value VALI from the SQ of the host memory 140 in response to a DMA signal XDMA transmitted from the first doorbell controller DCT1 after the second time point.

The network interface device 200 according to embodiments of the present disclosure may further include a request pipeline RQL, a completion pipeline CPL, and a WQE controller WCT.

The request pipeline RQL may perform pipelining on the send WQE WQE1 fetched from the SQ of the host memory 140 to output a request packet REQ. At this time, the request pipeline RQL may simultaneously perform processing on multiple send WQEs WQE1s or generation of multiple request packets REQs in parallel.

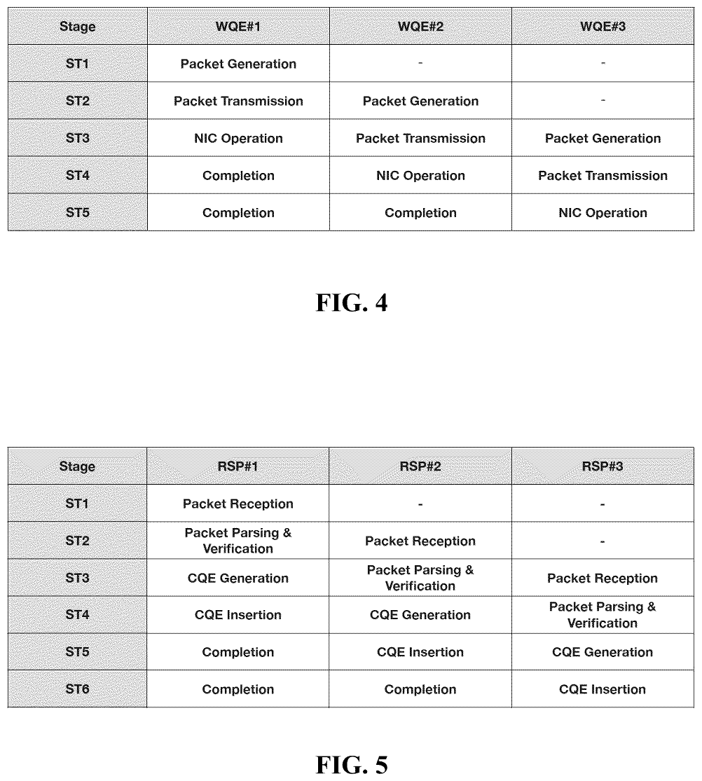

FIG. 4 is a view illustrating the operation of the request pipeline RQL according to an embodiment of the present disclosure.

Referring to FIGS. 3 and 4, the request pipeline RQL according to embodiments of the present disclosure may simultaneously perform the operation of generating three request packets REQs for three send WQE WQE1. In one embodiment, the operation of generating a request packet REQ may be divided into a packet generation operation, a packet transmission operation, and an NIC processing operation.

In one embodiment, the request pipeline RQL may set a packet header of the request packet REQ based on QP information or a key value included in the send WQE WQE1. The packet header of the request packet REQ may include a “base transport header” (BTH) or “RDMA extended transport header” (ETH). Alternatively, the request pipeline RQL may receive data stored at an address included in the send WQE WQE1 through the DMA engine DEG to form a packet payload of the request packet REQ. The request packet REQ may also include a cyclic redundancy check (CRC) field for integrity checking.

The packet transmission operation may include an operation of outputting the request packet REQ of the TX queue (not shown) through a protocol such as InfiniBand or RoCE. The NIC processing operation may include operations such as packet sequence number (PSN) update, retransmission processing waiting, or WQE status update.

In the example of FIG. 4, the request pipeline RQL may simultaneously perform the NIC processing operation for a first send WQE WQE #1 in stage ST3, the packet transmission operation for a second send WQE WQE #2, and the packet generation operation for a third send WQE WQE #3.

Referring back to FIGS. 1 to 3, the request packet REQ generated by the network interface device 200 of the initiator system 1000i may be transmitted to the target system 1000t through the network fabric. The network interface device 200 of the target system 1000t may transmit a response packet RSP corresponding to the request packet REQ to the initiator system 1000i through the network fabric.

The completion pipeline CPL may perform pipelining on the received response packet RSP to output the first CQE CQE1. The response packet RSP may be used in the form of “RDMA Read Response” or “acknowledgement” (ACK). These types of response packet RSP commonly include “BTH” as a packet header and “RDMA acknowledge header” (AETH) indicating a response status such as ACK or NAK, and in the case of “RDMA Read Response”, may further include a packet payload. The response packet RSP may also include a CRC field for integrity checking.

In receiving the response packet RSP and generating the first CQE CQE1, the completion pipeline CPL may perform processing operations on multiple response packets RSPs or multiple send WQEs WQE1s in parallel. In addition to generating the first CQE CQE1, the completion pipeline CPL may also perform processing on the send WQE WQE1 stored in the shared WQE memory SWM.

FIG. 5 is a view illustrating the operation of the completion pipeline CPL according to an embodiment of the present disclosure.

Referring to FIGS. 1, 3, and 5, the completion pipeline CPL according to an embodiment of the present disclosure may simultaneously perform operations of processing three first CQEs CQE1s for three response packets RSPs. In one embodiment, the operation of processing the first CQE CQE1 may be divided into a packet reception operation, a packet parsing and verification operation, and a CQE generation and CQE transmission operation.

The packet reception operation may include an operation of receiving a response packet RSP from an RX queue (not shown) to the completion pipeline CPL. The receive queue may buffer the response packet RSP received through the network fabric, and perform reordering if the response packet RSP is not received in order. The packet parsing and verification operation may include an operation of extracting field values of main fields of the response packet RSP and performing integrity verification to check if the packet is normal.

The CQE generation and CQE transmission operation may include an operation of generating a corresponding the first CQE CQE1 among the send WQE WQE1 stored in the shared WQE memory SWM through the extracted “WR ID” and “QP ID”, and transmitting it to the CQ of the host memory 140. When the CPU 120 of the host device 100 polls the first CQE CQE1 stored in the CQ, it may check the “WR ID” and process the corresponding the send WQE WQE1 as completed. However, it is not limited to this, and the completion pipeline CPL may store the generated the first CQE CQE1 in the internal completion queue of the network interface device 200, and notify the CPU 120 of the host device 100 of the generation of the first CQE CQE1 through a doorbell or interrupt method.

In the example of FIG. 5, the completion pipeline CPL may simultaneously perform a CQE generation operation for the first response packet RSP #1, a packet parsing and verification operation for the second response packet RSP #2, and a packet reception operation for the third response packet RSP #3 in stage ST3.

Although not shown, the request pipeline RQL may be included in the TX engine of the network interface device 200, and the completion pipeline CPL may be included in the RX engine of the network interface device 200.

Referring back to FIGS. 1 and 3, the WQE controller WCT according to an embodiment of the present disclosure may control the operation of the request pipeline RQL or the completion pipeline CPL accessing the shared WQE memory SWM.

As mentioned above, the shared WQE memory SWM may be shared for multiple QPs. In other words, entries of the shared WQE memory SWM are not fixed according to the QP number and the index within the QP, and may be used by different QPs. Therefore, accurate mapping management or tracking for entries of the shared WQE memory SWM may be required. For example, if an entry of the shared WQE memory SWM occupied by a QP is not released when the QP is removed, the entry may not be used by another QP.

In one embodiment, the WQE controller WCT may perform accurate entry tracking for the shared WQE memory SWM by reflecting the characteristics or types of memory commands received from the request pipeline RQL or the completion pipeline CPL. In one embodiment, the WQE controller WCT may sequentially access the shared WQE memory SWM in response to at least two or more memory commands received from the request pipeline RQL or the completion pipeline CPL.

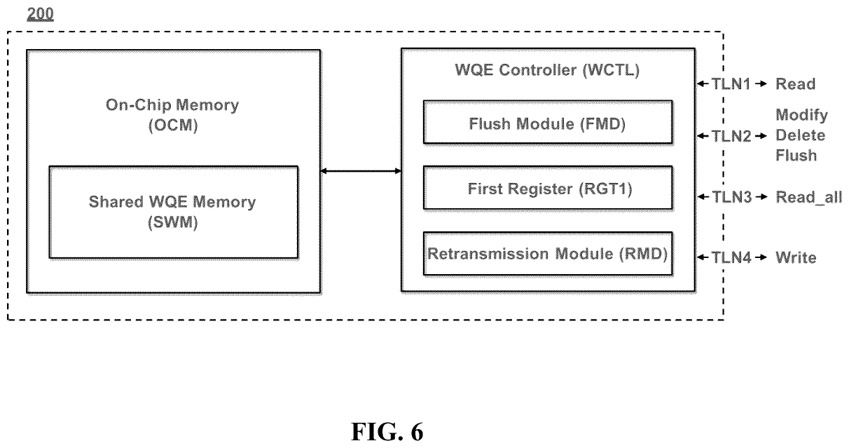

FIG. 6 is a view illustrating the operation of the WQE controller WCT according to an embodiment of the present disclosure.

Referring to FIGS. 3 and 6, the WQE controller WCT according to an embodiment of the present disclosure may be electrically connected to the request pipeline RQL and the completion pipeline CPL. In one embodiment, the WQE controller WCT may be connected to the request pipeline RQL and the completion pipeline CPL through separate transmission lines according to the types of memory commands.

In one embodiment, the WQE controller WCT and the completion pipeline CPL may be connected via a first transmission line TLN1 for transmitting a first type of memory command and a second transmission line TLN2 for transmitting a second type of memory command.

The first type of memory command may include a read command. In the operation process of generating a first CQE CQE1 from a response packet RSP corresponding to a request packet REQ, the completion pipeline CPL may transmit a read command to the WQE controller WCT through the first transmission line TLN1 to read the send WQE WQE1 stored in the shared WQE memory SWM.

The second type of memory command may include at least two or more of a modify command, a delete command, and a flush command.

If the response packet RSP is for a part of the request packet REQ, the completion pipeline CPL may transmit a modify command to the WQE controller WCT through the second transmission line TLN2 to update the send WQE WQE1 stored in the shared WQE memory SWM. When the network interface device 200 processes one send WQE WQE1 by dividing it into several data chunks, for example, when a “RDMA Read Request” of 4 KB data is processed by two response packets RSPs in 2 KB units, the send WQE WQE1 stored in the shared WQE memory SWM may be updated. For example, information on the remaining data size or WQE status of the send WQE WQE1 stored in the shared WQE memory SWM may be updated. If some of the send WQEs WQE1s stored in the shared WQE memory SWM are completed, the first CQE CQE1 for the partially completed send WQE WQE1 may be generated, or the first CQE CQE1 may be generated after the final completion.

When the processing for the send WQE WQE1 stored in the shared WQE memory SWM is completed, for example, when the first CQE CQE1 is generated and the corresponding send WQE WQE1 is consumed, the completion pipeline CPL may transmit a delete command to the WQE controller WCT.

The completion pipeline CPL may transmit a flush command to the WQE controller WCT through the second transmission line TLN2 when removing the QP. For the QP requested to be removed from the host device 100, the processing for the unfinished send WQE WQE1 of the QP may be forced to complete through the flush command.

In one embodiment, the WQE controller WCT and the completion pipeline CPL may be additionally connected to a third transmission line TLN3 for transmitting a third type of command.

The third type of command may include a read-all command. The read-all command may be executed before executing a flush command, or in a situation such as a timeout situation where a response packet RSP is not received for a certain time for a request packet REQ of “RDMA Read”, to ensure reliable data management.

In one embodiment, the WQE controller WCT and the request pipeline RQL may be connected by a fourth transmission line TLN4 for transmitting a fourth type of memory command. The fourth type of memory command may include a write command. The request pipeline RQL may transmit a write command to the WQE controller WCT through the fourth transmission line TLN4 to insert the send WQE WQE1 generated as a request packet REQ into the shared WQE memory SWM.

In one embodiment, the types of memory commands transmitted from the request pipeline RQL or the completion pipeline CPL to the WQE controller WCT through separate transmission lines may be set according to whether the memory commands may be executed synchronously or asynchronously. “Synchronous” or “Asynchronous” may be about whether the execution of one type of memory command affects the execution of another type of command. For example, in the case of synchronous execution, the next memory command will not be executed until the corresponding memory command is completed, but in the case of asynchronous execution, the next memory command may be executed before the corresponding memory command is completed.

According to the RDMA protocol, read commands, write commands, flush commands, and read-all commands may be executed asynchronously. The WQE controller WCT according to embodiments of the present disclosure may receive asynchronously executable read commands, write commands, flush commands, and read-all commands in parallel via separate transmission lines to prevent performance degradation, while sequentially processing access to the shared WQE memory SWM, thereby enabling accurate tracking of entries in the shared WQE memory SWM.

In one embodiment, unless a QP is being removed, flush commands, delete commands, and modify commands may not occur simultaneously or in close proximity for a specific QP. In such cases, in addition to flush commands, delete commands and modify commands may also be transmitted to the WQE controller WCT via the second transmission line TLN2. By transmitting memory commands that do not interfere with each other through a single transmission line to the WQE controller WCT, performance may be maintained with minimal resources.

The WQE controller WCT according to embodiments of the present disclosure may control operations corresponding to memory commands received from the request pipeline RQL or the completion pipeline CPL. In one embodiment, the WQE controller WCT may include a first register RGT1, a flush module FMD, and a retransmission module RMD.

The first register RGT1 stores head pointers and tail pointers of the request pipeline RQL and the completion pipeline CPL. The request pipeline RQL may increment its internally stored pointer by one each time a request occurs. The completion pipeline CPL may decrement its internally stored pointer by one each time a request is processed.

When a write command from the request pipeline RQL or a delete command from the completion pipeline CPL is transmitted to the WQE controller WCT, the head pointers and/or tail pointers stored internally in the request pipeline RQL and the completion pipeline CPL may also be transmitted and stored or updated in the first register RGT1.

In one embodiment, the head pointer may represent the value of the most recent request for a specific QP, and the tail pointer may represent the value of the oldest request for that QP. In one embodiment, when a write command is received from the request pipeline RQL, the head pointer in the first register RGT1 may be updated. In one embodiment, when a read command is received from the completion pipeline CPL, the tail pointer in the first register RGT1 may be updated.

Additionally, the head pointer and/or tail pointer in the first register RGT1 may be updated based on the operations of the flush module FMD and the retransmission module RMD described below.

The flush module FMD may process flush commands for the shared WQE memory SWM. When a flush command is received via the second transmission line TLN2, the flush module FMD may delete all send WQEs WQE1s stored in the shared WQE memory SWM in the region corresponding to the head pointer and tail pointer in the first register RGT1. In one embodiment, the flush module FMD may refer to the first table TBL1 of the shared WQE memory SWM to delete all entries in the shared WQE memory SWM from the entry corresponding to the head pointer to the entry corresponding to the tail pointer in the main region MRG.

The retransmission module RMD may process read-all commands for the shared WQE memory SWM. When a read-all command is received via the third transmission line TLN3, the retransmission module RMD may read all send WQEs WQE1s stored in the shared WQE memory SWM in the region corresponding to the head pointer and tail pointer in the first register RGT1. In one embodiment, the flush module FMD may refer to the first table TBL1 of the shared WQE memory SWM to read all entries in the shared WQE memory SWM from the entry corresponding to the head pointer to the entry corresponding to the tail pointer in the main region MRG.

The retransmission module RMD may be provided separately from the flush module FMD. The flush module FMD and the retransmission module RMD may be activated simultaneously or separately.

Although not shown, the WQE controller WCT may further include a module that reads send WQEs WQE1s stored in the main region MRG of the shared WQE memory SWM in response to a read command and a module that writes send WQEs WQE1s to the main region MRG of the shared WQE memory SWM in response to a write command. In one embodiment, the module for reading send WQEs WQE1s or the module for writing send WQEs WQE1s may be provided separately from the flush module FMD or the retransmission module RMD. The same may apply to a module performing a modify command.

When a flush command or read-all command is executed in the completion pipeline CPL, the WQE controller WCT prevents a situation where the entire pipeline stalls (rather than just the stage of the respective memory command), thereby maintaining the performance of the network interface device 200 while significantly reducing the on-chip memory usage of send WQEs WQE1s. In one embodiment, the network interface device 200 may reduce the on-chip memory OCM usage of the send WQE WQE1 to 1 MB or less while maintaining a performance of 100 Gbps.

The first table TBL1 and the second table TBL2 of the shared WQE memory SWM may be updated by the WQE controller WCT to reflect newly stored or deleted send WQEs WQE1s.

The shared WQE memory SWM, the on-chip memory OCM, the doorbell controller DCT1, the DMA engine DEG, the request pipeline RQL, the completion pipeline CPL, and the WQE controller WCT shown in FIG. 3 may collectively be included in the request processing module 220 of FIG. 1. In one embodiment, the on-chip memory OCM and the DMA engine DEG may be shared with the response processing module 240 of FIG. 1.

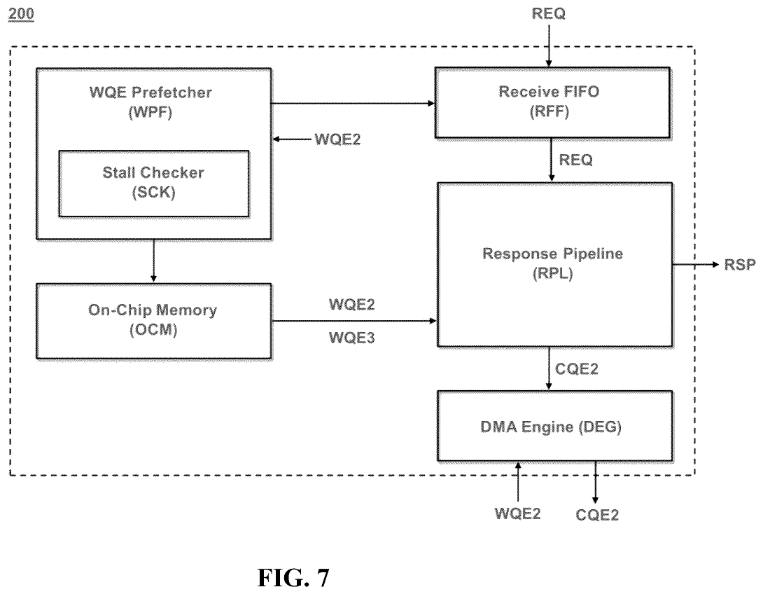

FIG. 7 is a view illustrating the operation of generating the response packet RSP according to an embodiment of the present disclosure.

Referring to FIGS. 1 and 7, the network interface device 200 according to an embodiment of the present disclosure may include the WQE prefetcher WPF and a response pipeline RSL. The WQE prefetcher WPF may prefetch M receive WQEs WQE2s. M may be a positive integer less than or equal to 1/m of X*Y, where m may be a positive integer of 2 or more.

The RQ of the host memory 140 may store a receive WQEsWQE2 up to the queue depth. As in the aforementioned example, 1,024 receive WQEs WQE2s may be stored in the RQ for each of the 10,000 QP connections. The host device 100 may notify the network interface device 200 of how many in-flight receive WQEs WQE2s exist at a specific time point through a doorbell.

As the network interface device 200 receives a request packet REQ, the receive WQE WQE2 in the RQ of the host memory 140 may be consumed. In one embodiment, the receive WQEs WQE2s may be consumed in the order in which they are stored in the RQ of the host memory 140.

The network interface device 200 according to embodiments of the present disclosure may store the receive WQE WQE2 from the receive queue of the host memory 140 in the on-chip memory OCM through the DMA engine DEG, and consume them to generate the response packet RSP corresponding to the request packet REQ. By prefetching M receive WQEs WQE2s, the WQE prefetcher WPF of the network interface device 200 may reduce the DMA latency for reading the receive WQE WQE2 from the host memory 140 while minimizing the usage of the on-chip memory OCM.

In one embodiment, the number M of receive WQEs WQE2s prefetched and stored in the on-chip memory OCM may be set based on the network bandwidth, the average number of received request packets REQs, and the DMA latency of the host device 100. For example, in a 400 Gbps bandwidth situation, a request packet REQ may be received one by one in about 80 ns, and if the DMA latency from the host memory 140 to the network interface device 200 is about 1 μs, the performance of generating a response packet RSP may be maintained if about 12.5 or more receive WQEs WQE2s are stored in the network interface device 200.

In this case, the network interface device 200 according to embodiments of the present disclosure may set M to “16” in consideration of other variables. The WQE prefetcher WPF may perform the prefetching operation so that the number of receive WQEs WQE2s stored in the on-chip memory OCM is maintained at 16.

In one embodiment, M may be set smaller than N to minimize resources without causing performance degradation.

In one embodiment, when there are no receive WQE WQE2 stored in the on-chip memory OCM in the initialization stage, if M or more receive WQEs WQE2s are stored in the host memory 140, the WQE prefetcher WPF may prefetch M receive WQEs WQE2s. In one embodiment, if the number of receive WQEs WQE2s stored in the on-chip memory OCM becomes less than or equal to a certain number due to the processing of received request packet REQ, the WQE prefetcher WPF may additionally perform a prefetching operation. In one embodiment, if the number of receive WQEs WQE2s stored in the on-chip memory OCM becomes less than or equal to ½ of M, the WQE prefetcher WPF may prefetch receive WQEs WQE2s from the host memory 140 by the extra number.

The response pipeline RSL may process the receive WQE WQE2 prefetched by the WQE prefetcher WPF to generate the response packet RSP corresponding to the request packet REQ. The response pipeline RSL may transmit the generated response packet RSP to the initiator system 1000i of FIG. 2 through the network fabric, and generate the second CQE CQE2 indicating that the processing of the receive WQE WQE2 is completed. In performing the above operations, the response pipeline RSL may perform processing operations for a plurality of request packets REQs in parallel.

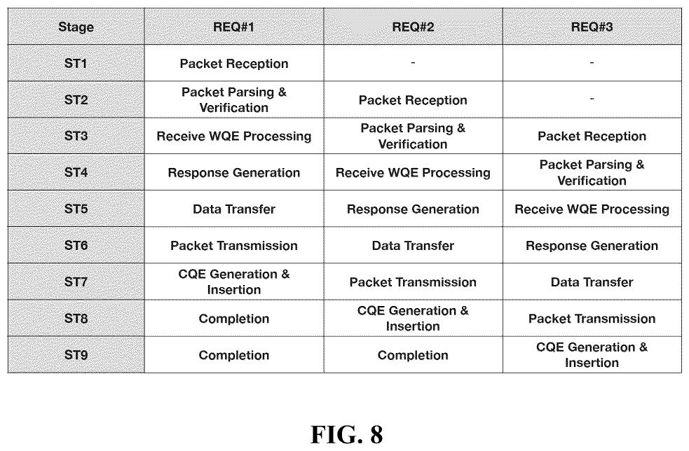

FIG. 8 is a view illustrating the operation of the response pipeline RSL according to an embodiment of the present disclosure.

Referring to FIGS. 7 and 8, the response pipeline RSL according to embodiments of the present disclosure may simultaneously perform operations of generating three response packets RSPs for three request packets REQs. In one embodiment, the operation of generating a response packet RSP may be divided into a packet reception operation, a packet parsing and verification operation, a receive WQE processing operation, a packet generation operation, a data movement operation, and a CQE generation and storage operation.

The packet reception operation, the packet parsing and verification operation, and the packet transmission operation may be similar to the operations of the completion pipeline CPL described above. The receive WQE processing operation may be an operation of reading the receive WQE WQE2 pre-charged in the on-chip memory OCM or changing the status of the receive WQE WQE2. As described above, the packet generation operation may include an operation of generating a response packet RSP composed of “BTH”, “ETH” and/or “AETH” and a packet payload if necessary. The data movement operation may include an operation of storing data at a memory address specified by the receive WQE WQE2 through the DMA engine. The CQE generation and storage operation may include an operation of generating a second CQE CQE2 indicating that the receive WQE WQE2 has been consumed and storing it in the CQ of the host memory 140.

In the example of FIG. 8, the response pipeline RSL may simultaneously perform a packet generation operation for the first request packet REQ #1 a receive WQE processing operation for the second request packet REQ #2, and a packet parsing and verification operation for the third request packet REQ #3 in stage ST4.

Referring back to FIGS. 1 and 7, the WQE prefetcher WPF according to embodiments of the present disclosure may prevent packet drops even if the DMA latency is extended due to jitter in the system.

In one embodiment, if the receive WQE WQE2 corresponding to the request packet REQ to be processed by the response pipeline RSL at an arbitrary time point is absent in the on-chip memory OCM, the WQE prefetcher WPF may control a null WQE WQE3 to be transmitted to the response pipeline RSL. The null WQE WQE3 may be generated with all bits having a value of “0”, or fields such as “Opcode” or “Flag” having specific values, and stored in the on-chip memory OCM. The null WQE WQE3 may be generated by the WQE prefetcher WPF, but it is not limited thereto. The null WQE WQE3 may also be generated by another logic of the network interface device 200.

Upon receiving the null WQE WQE3, the response pipeline RSL may output an error response, for example, a Receiver Not Ready (RNR) packet RNR. The initiator system 1000i that receives the RNR packet RNR may not retransmit the request packet REQ during the time interval indicated by the RNR packet RNR.

The WQE prefetcher WPF may determine whether to stall the response pipeline RSL based on the number of available entries in the receive First-In-First-Out (FIFO) RFF. The request packet REQ received by the network interface device 200 may be stored in the receive FIFO RFF before being transmitted to the response pipeline RSL. The receive FIFO RFF may transmit the request packets REQs to the response pipeline RSL in the order in which they are received.

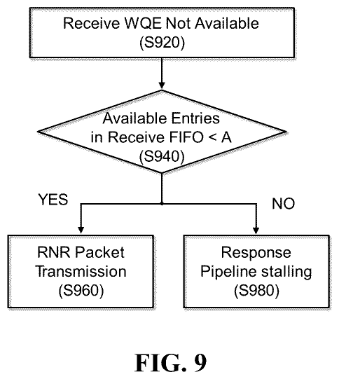

FIG. 9 is a flowchart illustrating a portion of the operation of the WQE prefetcher WPF according to an embodiment of the present disclosure.

Referring to FIGS. 7 and 9, the WQE prefetcher WPF according to embodiments of the present disclosure may include a stall checker SCK. When the receive WQE WQE2 corresponding to an arbitrary request packet REQ is absent in the on-chip memory OCM (S920), if the number of available entries in the receive FIFO RFF is less than or equal to a certain number (“YES” in S940), that is, if the number of request packets REQs waiting in the receive FIFO RFF is greater than or equal to a certain number, the stall checker SCK of the WQE prefetcher WPF may control the response pipeline RSL to process the null WQE WQE3 and output an RNR packet RNR as described above (S960). In this case, the response pipeline RSL may process the response packet RSP for the request packet REQ as an RNR packet RNR. Therefore, packet drops due to the stall of the response pipeline RSL may be prevented.

On the other hand, when the receive WQE WQE2 corresponding to an arbitrary request packet REQ is absent in the on-chip memory OCM (S920), if the number of available entries in the receive FIFO RFF is greater than or equal to a certain number (“NO” in S940), the WQE prefetcher WPF may control the response pipeline RSL to stall until the receive WQE WQE2 is transmitted from the host memory 140 to the on-chip memory OCM (S980). If the number of subsequent request packet REQ to be processed is less than a certain number, packet drops may not occur even if the response pipeline RSL temporarily stalls. Therefore, performance degradation that may occur because the initiator system 1000i does not retransmit the request packet REQ for a certain time in response to the RNR packet RNR may be prevented.

As such, according to the interface device 200 and the system 1000 of the present disclosure, the performance degradation due to the processing of RNR packets may be amortized while preventing packet drops.

The WQE prefetcher WPF, the response pipeline RSL, the receive FIFO RFF, the DMA engine DEG, and the on-chip memory OCM of FIG. 7 may be included in the response processing module 240 of FIG. 1 together. In one embodiment, the DMA engine DEG and the on-chip memory OCM may be shared with the request processing module 220 of FIG. 1.

Through the above structure or operation, the on-chip memory usage of the receive WQE WQE2 may be significantly reduced while maintaining the performance of the network interface device 200 according to embodiments of the present disclosure. According to one embodiment, the network interface device 200 may reduce the on-chip memory OCM usage of the receive WQE WQE2 to 15 MB or less while maintaining 100 Gbps performance.

As such, according to the network interface device 200 and the system 1000 including the same of the present disclosure, it is possible to support a certain number of QP connections or more while maintaining high bandwidth and low latency by including a shared work queue element memory or a WQE prefetcher. According to an embodiment, when a remote direct memory access (RDMA) protocol is applied, the network interface device and the system including the same according to embodiments of the present disclosure can maintain a high bandwidth of 100 Gbps while simultaneously processing more than 10,000 QP connections. In addition, according to the network interface device 200 and the system 1000 including the same of the present disclosure, it is possible to provide connection scalability in a state compatible with commercial network interface devices. Moreover, according to a network interface device and a system including the same of the present disclosure, changes to the network protocol are unnecessary, so connection scalability can be provided in a state compatible with commercial network interface devices. Furthermore, according to the network interface device 200 and the system 1000 including the same of the present disclosure, high performance and high scalability can be supported by minimizing CPU intervention in request processing or response processing.

In one embodiment, a network interface device is a network interface device for simultaneously processing Y (where Y is a positive integer of 2 or more) queue pair (QP) connections for X (where X is a positive integer) send work queue elements (WQEs) or receive WQEs, the network interface device includes: a shared WQE memory having a size corresponding to N (where N is a positive integer less than or equal to 1/n of X*Y, n is a positive integer of 2 or more) send WQEs; and a first doorbell controller configured to count free regions of the shared WQE memory and control processing of a first doorbell received from an external source.

In one embodiment, N may set corresponding to a network bandwidth, a number of end-to-end switch hops, and a switch processing latency.

In one embodiment, the shared WQE memory may include: a main region configured to store at least one of the send WQEs; a first table configured to store an index for a region where the at least one of the send WQEs is stored in the main region, and a QP identifier corresponding to the at least one of the send WQEs indicated by the index; and a second table configured to store at least one index for the free regions in the main region.

In one embodiment, the network interface device may further include: a request pipeline configured to perform pipelining on the send WQEs to output a request packet; a completion pipeline configured to perform pipelining on a response packet received corresponding to the request packet to output a completion queue element (CQE); and a WQE controller configured to sequentially access the shared WQE memory in response to at least two or more memory commands received from the request pipeline or the completion pipeline.

In one embodiment, the completion pipeline and the WQE controller may be connected by: a first transmission line configured to transmit a first type of memory command; and a second transmission line configured to transmit a second type of memory command.

In one embodiment, the completion pipeline and the WQE controller may be connected by: a first transmission line configured to transmit a first type of memory command; a second transmission line configured to transmit a second type of memory command; and a third transmission line configured to transmit a third type of memory command.

In one embodiment, the first type of memory command may include a read command; the second type of memory command may include at least two of a modify command, a delete command, and a flush command; and the third type of memory command may include a read-all command.

In one embodiment, the WQE controller may include a first register configured to update a head pointer or a tail pointer for a corresponding QP in response to a memory command received from the request pipeline and the completion pipeline; a flush module configured to process a flush command for the shared WQE memory; and a retransmission module separated from the flush module and configured to process a read-all command for the shared WQE memory.

In one embodiment, the first doorbell controller may be configured to ignore the first doorbell when a first value indicated by the first doorbell is larger than a count value for the free regions in the shared WQE memory.

In one embodiment, the network interface device may further include a WQE prefetcher configured to prefetch M (where M is a positive integer less than or equal to 1/m of X*Y, m is a positive integer of 2 or more) receive WQEs.

In one embodiment, M may be set corresponding to a network bandwidth, an average number of received request packets, and a DMA latency.

In one embodiment, the network interface device may further include: a response pipeline configured to process a receive WQE delivered via the WQE prefetcher to generate a response packet corresponding to a request packet; and a receive First-In-First-Out (FIFO) configured to receive the request packet and transmit the received request packet to the response pipeline in the order received.

In one embodiment, the WQE prefetcher may include a stall checker configured to check the number of available entries in the receive FIFO and control one of a receive WQE and a null WQE to be transmitted to the response pipeline.

In one embodiment, the response pipeline may be configured to output an error response when a null WQE is received from the WQE prefetcher.

In one embodiment, a network interface device is a network interface device for simultaneously processing Y (where Y is a positive integer of 2 or more) queue pair (QP) connections for X (where X is a positive integer) send work queue elements (WQEs) or receive WQEs, the network interface device includes: a WQE prefetcher configured to prefetch M (where M is a positive integer less than or equal to 1/m of X*Y, m is a positive integer of 2 or more) receive WQEs; and a response pipeline configured to output an error response when a null WQE is received via the WQE prefetcher.

In one embodiment, the network interface device may further include a shared WQE memory having a size corresponding to N (where N a positive integer less than or equal to 1/n of X*Y, n is a positive integer of 2 or more) send WQEs.

In one embodiment, the network interface device may further include a first doorbell controller configured to count free regions in the shared WQE memory and control processing of a first doorbell received from an external source.

In one embodiment, the network interface device may further include a receive First-In-First-Out (FIFO) configured to receive request packets and transmit the request packets to the response pipeline in the order received.

In one embodiment, a system includes a network interface device for simultaneously processing Y (where Y is a positive integer of 2 or more) queue pair (QP) connections for X (where X is a positive integer) send work queue elements (WQEs) or receive WQEs, wherein the network interface device includes: a request processing module configured to process remote direct memory access (RDMA) requests, including a shared WQE memory having a size corresponding to N (where N is a positive integer less than or equal to 1/n of X*Y, n is a positive integer of 2 or more) send WQEs; and a response processing module configured to process RDMA responses corresponding to the RDMA requests, including a WQE prefetcher configured to prefetch M (where M is a positive integer less than or equal to 1/m of X*Y, m is a positive integer of 2 or more) receive WQEs.

In one embodiment, M may be set smaller than N.

The various embodiments of the present disclosure and the terms used in the embodiments are not intended to limit the technical features described in the present disclosure to specific embodiments, and should be understood to include various modifications, equivalents, or alternatives of the embodiments. For example, a component expressed in the singular should be understood as a concept including a plurality of components unless the context clearly indicates that only the singular is meant. It is to be understood that the term “and/or” as used in this disclosure is intended to encompass any and all possible combinations of one or more of the items listed.

The terms “include,” “have,” “be composed of,” and the like used in this disclosure are only intended to specify the presence of the features, components, parts, or a combination thereof described in this disclosure, and are not intended to exclude the presence or addition of one or more other features, components, parts, or combinations thereof by the use of such terms. In this disclosure, each of the phrases such as “A or B”, “at least one of A and B”, “at least one of A or B”, “A, B or C”, “at least one of A, B and C”, and “at least one of A, B, or C” may include any one of the items listed together in the corresponding phrase among the phrases, or all possible combinations thereof. Terms such as “first”, “second”, or “first” or “second” may be used simply to distinguish the component from another corresponding component, and do not limit the components in other aspects (for example, importance or order).

The term “˜unit”, “˜block”, “˜logic” or “˜module” used in various embodiments of the present disclosure may include a unit implemented by hardware, software or firmware, and for example, may be used interchangeably with terms such as logic, logic block, component, or circuit. The “˜unit”, “˜block”, “˜logic” or “˜module” may be an integral component, or the minimum unit or a part of the component that performs one or more functions. For example, according to one embodiment, the “˜unit”, “˜block”, “˜logic” or “˜module” may be implemented in the form of an application-specific integrated circuit (ASIC) or a field-programmable gate array (FPGA).

The term “when ˜” used in various embodiments of the present disclosure may be interpreted to mean “when”, “at the time of”, “in response to determining”, or “in response to detecting” depending on the context. Similarly, “if ˜ is determined” or “if ˜ is detected” may be interpreted to mean “at the time of determination” or “in response to determining”, or “at the time of detection” or “in response to detecting” depending on the context.

The programs executed in the network interface device and the system including the same described through the present disclosure may be implemented by hardware components, software components, and/or a combination of hardware components and software components. The programs may be executed by any system capable of executing computer-readable instructions.

Software may include a computer program, code, instructions, or a combination of one or more thereof, and may configure a processing device to operate as desired or command the processing device independently or collectively. Software may be implemented as a computer program including instructions stored on a computer-readable storage medium. Examples of the computer-readable storage medium include a magnetic storage medium (for example, read-only memory (ROM), random-access memory (RAM), floppy disk, hard disk, etc.) and an optical reading medium (for example, CD-ROM, digital versatile disc (DVD)).

The computer-readable storage medium may be distributed over networked computer systems so that computer-readable code is stored and executed in a distributed manner. The computer program may be distributed (for example, downloaded or uploaded) online through an application store (for example, Play Store™) or directly between two user devices (for example, smart phones). In the case of online distribution, at least a portion of the computer program product may be at least temporarily stored in a device-readable storage medium such as a memory of a manufacturer's server, an application store's server, or a relay server, or may be temporarily generated.

According to various embodiments of the present disclosure, each component of the components described above (for example, module or program) may include a single or plural entities, and some of the plural entities may be separately arranged in other components. According to various embodiments, one or more of the aforementioned corresponding components or operations may be omitted, or one or more other components or operations may be added. Alternatively or additionally, a plurality of components (for example, modules or programs) may be integrated into one component. In this case, the integrated component may perform one or more functions of each of the plurality of components in the same or similar manner as performed by the corresponding component among the plurality of components before the integration. According to various embodiments, the operations performed by the modules, programs, or other components may be executed sequentially, in parallel, repeatedly, or heuristically, or one or more of the operations may be executed in a different order, omitted, or one or more other operations may be added.

What is claimed is:

1. A network interface device for simultaneously processing Y queue pair (QP) connections for X send work queue elements (WQEs) or receive WQEs, wherein Y is a positive integer of 2 or more and X is a positive integer, the network interface device comprising:
a shared WQE memory having a size corresponding to N send WQEs, wherein N is a positive integer less than or equal to 1/n of X*Y, and n is a positive integer of 2 or more; and
a first doorbell controller configured to count free regions of the shared WQE memory and control processing of a first doorbell received from an external source.

2. The network interface device of claim 1, wherein N is set corresponding to a network bandwidth, a number of end-to-end switch hops, and a switch processing latency.

3. The network interface device of claim 1, wherein the shared WQE memory comprises:
a main region configured to store at least one of the send WQEs;
a first table configured to store an index for a region where the at least one of the send WQEs is stored in the main region, and a QP identifier corresponding to the at least one of the send WQEs indicated by the index; and
a second table configured to store at least one index for the free regions in the main region.

4. The network interface device of claim 1, further comprising:
a request pipeline configured to perform pipelining on the send WQEs to output a request packet;
a completion pipeline configured to perform pipelining on a response packet received corresponding to the request packet to output a completion queue element (CQE); and
a WQE controller configured to sequentially access the shared WQE memory in response to at least two or more memory commands received from the request pipeline or the completion pipeline.

5. The network interface device of claim 4, wherein the completion pipeline and the WQE controller are connected by:
a first transmission line configured to transmit a first type of memory command; and
a second transmission line configured to transmit a second type of memory command.

6. The network interface device of claim 4, wherein the completion pipeline and the WQE controller are connected by:
a first transmission line configured to transmit a first type of memory command;
a second transmission line configured to transmit a second type of memory command; and
a third transmission line configured to transmit a third type of memory command.

7. The network interface device of claim 6, wherein:
the first type of memory command includes a read command;
the second type of memory command includes at least two of a modify command, a delete command, and a flush command; and
the third type of memory command includes a read-all command.

8. The network interface device of claim 4, wherein the WQE controller comprises:
a first register configured to update a head pointer or a tail pointer for a corresponding QP in response to a memory command received from the request pipeline and the completion pipeline;
a flush module configured to process a flush command for the shared WQE memory; and
a retransmission module separated from the flush module and configured to process a read-all command for the shared WQE memory.

9. The network interface device of claim 1, wherein the first doorbell controller is configured to ignore the first doorbell when a first value indicated by the first doorbell is larger than a count value for the free regions in the shared WQE memory.

10. The network interface device of claim 1, further comprising:
a WQE prefetcher configured to prefetch M receive WQEs, wherein M is a positive integer less than or equal to 1/m of X*Y, and m is a positive integer of 2 or more.

11. The network interface device of claim 10, wherein M is set corresponding to a network bandwidth, an average number of received request packets, and a DMA latency.

12. The network interface device of claim 10, further comprising:
a response pipeline configured to process a receive WQE delivered via the WQE prefetcher to generate a response packet corresponding to a request packet; and
a receive First-In-First-Out (FIFO) configured to receive the request packet and transmit the received request packet to the response pipeline in the order received.

13. The network interface device of claim 12, wherein the WQE prefetcher comprises:
a stall checker configured to check the number of available entries in the receive FIFO and control one of the receive WQE and a null WQE to be transmitted to the response pipeline.

14. The network interface device of claim 12, wherein the response pipeline is configured to output an error response when a null WQE is received from the WQE prefetcher.

15. A network interface device for simultaneously processing Y queue pair (QP) connections for X send work queue elements (WQEs) or receive WQEs, wherein Y is a positive integer of 2 or more and X is a positive integer, the network interface device comprising:
a WQE prefetcher configured to prefetch M receive WQEs, wherein M is a positive integer less than or equal to 1/m of X*Y, m is a positive integer of 2 or more; and
a response pipeline configured to output an error response when a null WQE is received via the WQE prefetcher.

16. The network interface device of claim 15, further comprising:
a shared WQE memory having a size corresponding to N send WQEs, where N is a positive integer less than or equal to 1/n of X*Y, and n is a positive integer of 2 or more.

17. The network interface device of claim 16, further comprising:
a first doorbell controller configured to count free regions in the shared WQE memory and control processing of a first doorbell received from an external source.

18. The network interface device of claim 15, further comprising:
a receive First-In-First-Out (FIFO) configured to receive request packets and transmit the request packets to the response pipeline in the order received.

19. A system comprising:
a network interface device for simultaneously processing Y queue pair (QP) connections for X send work queue elements (WQEs) or receive WQEs,
wherein Y is a positive integer of 2 or more and X is a positive integer, and
wherein the network interface device comprises:
a request processing module configured to process remote direct memory access (RDMA) requests, including a shared WQE memory having a size corresponding to N send WQEs, wherein N is a positive integer less than or equal to 1/n of X*Y, and n is a positive integer of 2 or more; and
a response processing module configured to process RDMA responses corresponding to the RDMA requests, including a WQE prefetcher configured to prefetch M receive WQEs, wherein M is a positive integer less than or equal to 1/m of X*Y, and m is a positive integer of 2 or more.

20. The system of claim 19, wherein M is set smaller than N.
